(19) United States
(12) Patent Application Publication
(10) Pub. No.: US 2010/0244713 A1
(43) Pub. Date: Sep. 30, 2010

(54) ILLUMINATION APPARATUS USING LIGHT EMITTING DIODE

(75) Inventors: Jae Shin Lee, Anyang (KR); Hak Sun Kim, Daejeon (KR); Woo Chul Jeon, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/572,643

(22) Filed: Oct. 2, 2009

(30) Foreign Application Priority Data
Mar. 25, 2009 (KR) 10-2009-0025317

(51) Int. Cl. H05B 37/02

(52) U.S. Cl. 315/192; 315/291

(57) ABSTRACT

An illumination apparatus using a light emitting diode is directly driven by an alternating current (AC) power source, displays colors and simultaneously controls a color's brightness level. The illumination apparatus includes a power terminal unit to which an AC power source is applied; a variable current unit connected to one end of the power terminal unit, dividing current provided from the power terminal unit into a plurality of current levels, and including first, second and third variable current units controlling the plurality of divided current levels, respectively; and a light emitting unit including red, green, and blue light emitting units, respectively disposed between the first variable current unit and the other end of the power terminal unit, between the second variable current unit and the other end of the power terminal unit, and between the third variable current unit and the other end of the power terminal unit.

### CROSS-REFERENCE TO RELATED APPLICATIONS

This application claims the priority of Korean Patent Application No. 10-2009-0025317 filed on Mar. 25, 2009, in the Korean Intellectual Property Office, the disclosure of which is incorporated herein by reference.

### BACKGROUND OF THE INVENTION

1. Field of the Invention

The present invention relates to an illumination apparatus using a light emitting diode (hereinafter, also referred to as an “LED illumination apparatus”), and more particularly, to an LED illumination apparatus directly driven by an alternating current (AC) power source, displaying colors, and simultaneously controlling a color's brightness level.

2. Description of the Related Art

In general, a light emitting diode (LED) is a two-electrode element that emits light only when current flows therethrough. Due to LED's characteristics such as a high response rate, low power consumption, and a semi-permanent lifetime, LEDs are variously used for the backlights of liquid crystal displays (LCD), LED traffic signal lights, LED lighting devices, and the like.

In a traditional LED driving method, constant voltage and constant current drive operations are used extensively. In such drive operations, after alternating current/direct current (AC/DC) conversion and direct current/direct current (DC/DC) conversion, constant current or constant voltage drivers drive LEDs.

However, such drivers, which drive the LEDs by a constant current or constant voltage mechanism after the AC/DC conversion and the DC/DC conversion, cause increases in price and size.

In order to address these problems, a method of driving LEDs directly, through the use of a 110V or 220V AC common power source, has been suggested.

However, such an AC driving method is limited to the display of white light, so it is not easy to display various colors or control brightness levels according to color. This causes difficulty in dealing with mood lights.

### SUMMARY OF THE INVENTION

An aspect of the present invention provides an illumination apparatus using a light emitting diode (LED) capable of displaying various colors and controlling brightness levels according to color, and further having a high color rendering ability.

According to an aspect of the present invention, there is provided an illumination apparatus using an LED including: a power terminal unit having one end and the other end to which an alternating current power source is applied; a variable current unit connected to one end of the power terminal unit, dividing current provided from the power terminal unit into a plurality of current levels corresponding to a plurality of paths, and including first, second and third variable current units controlling the plurality of divided current levels, respectively; and a light emitting unit including a red light emitting unit disposed between the first variable current unit and the other end of the power terminal unit, a green light emitting unit disposed between the second variable current unit and the other end of the power terminal unit, and a blue light emitting unit disposed between the third variable current unit and the other end of the power terminal unit.

Each of the first, second and third variable current units may include a variable resistor.

Each of the red, green, and blue light emitting units may include first and second red light emitting units connected in parallel, first and second green light emitting units connected in parallel, and first and second blue light emitting units connected in parallel, respectively.

Each of the first and second red light emitting units, each of the first and second green light emitting units, and each of the first and second blue light emitting units may include one or at least two of series-connected red, green, and blue LEDs, respectively. Each of the first and second red light emitting units, each of the first and second green light emitting units, and each of the first and second blue light emitting units may have their respective polarities connected by a reversed-polarity connection

The variable current unit may further include a fourth variable current unit connected in parallel with the third variable current unit.

The light emitting unit may further include first and second white light emitting units disposed between the fourth variable current unit and the other end of the power terminal unit and connected in parallel to each other.

Each of the first and second white light emitting units may include one or at least two of series-connected white LEDs. The first and second white light emitting units may be connected by a reversed-polarity connection.

According to another aspect of the present invention, there is provided an illumination apparatus using an LED including: a power terminal unit having one end and the other end to which an alternating current power source is applied; a main variable current unit connected to one end of the power terminal unit and controlling current; an auxiliary variable current unit connected to an output port of the main variable current unit, dividing current provided from the main variable current unit into a plurality of current levels corresponding to a plurality of paths, and including first, second and third auxiliary variable current units controlling the plurality of divided current levels, respectively; and a light emitting unit including a red light emitting unit disposed between the first auxiliary variable current unit and the other end of the power terminal unit, a green light emitting unit disposed between the second auxiliary variable current unit and the other end of the power terminal unit, and a blue light emitting unit disposed between the third auxiliary variable current unit and the other end of the power terminal unit.

The main variable current unit and each of the first, second, and third auxiliary variable current units may include a variable resistor.

Each of the red, green, and blue light emitting units may include first and second red light emitting units connected in parallel, first and second green light emitting units connected in parallel, and first and second blue light emitting units connected in parallel, respectively.

Each of the first and second red light emitting units, each of the first and second green light emitting units, and each of the first and second blue light emitting units may include one or at least two of series-connected red, green, and blue LEDs, respectively. Each of the first and second red light emitting units, each of the first and second green light emitting units, and each of the first and second blue light emitting units may have their respective polarities connected by a reversed-polarity connection.

The auxiliary variable current unit may further include a fourth auxiliary variable current unit connected in parallel with the third auxiliary variable current unit.

The light emitting unit may further include first and second white light emitting units disposed between the fourth auxiliary variable current unit and the other end of the power terminal unit and connected in parallel to each other.

Each of the first and second white light emitting units may include one or at least two of series-connected white LEDs. The first and second white light emitting units may be connected by a reversed-polarity connection.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a configuration for an illumination apparatus using a light emitting diode (LED) according to an exemplary embodiment of the present invention;

FIG. 2 illustrates a configuration for an illumination apparatus using an LED according to another exemplary embodiment of the present invention;

FIG. 3 illustrates a configuration for an illumination apparatus using an LED according to another exemplary embodiment of the present invention; and

FIG. 4 illustrates a configuration for an illumination apparatus using an LED according to another exemplary embodiment of the present invention.

### DETAILED DESCRIPTION OF THE PREFERRED EMBODIMENT

Exemplary embodiments of the present invention will now be described in detail with reference to the accompanying drawings.

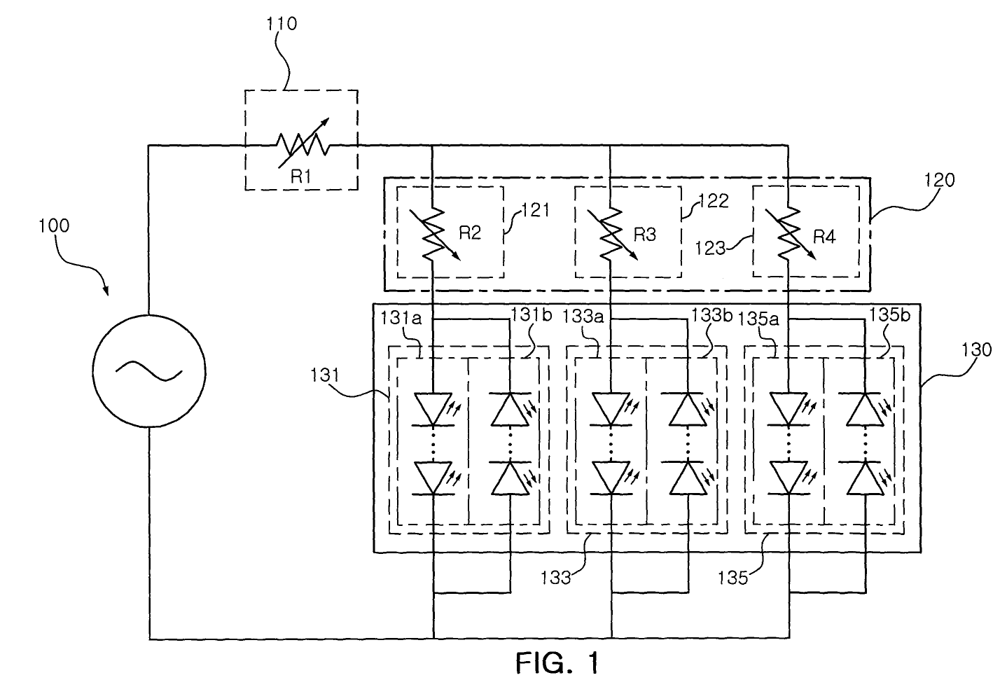

FIG. 1 is a configuration for an illumination apparatus using a light emitting diode (LED) according to an exemplary embodiment of the present invention.

As shown in FIG. 1, an illumination apparatus using a light emitting diode (hereinafter, also referred to as “LED illumination apparatus”) according to an exemplary embodiment of the invention includes a power terminal unit 100 to which an alternating current (AC) power source is applied, a main variable current unit 110 connected to one end of the power terminal unit 100 and controlling the entirety of the current, an auxiliary variable current unit 120 connected in parallel with an output port of the main variable current unit 110, dividing the current provided from the main variable current unit 110 into a plurality of current levels corresponding to a plurality of paths and controlling the plurality of divided current levels, and a light emitting unit 130 disposed between the auxiliary variable current unit 120 and the other end of the power terminal unit 100. Here, the light emitting unit 130 includes red, green, and blue LEDs so as to display various colors.

Through one end and the other end of the power terminal unit 100, a 110V or 220V common power source is applied.

The main variable current unit 110 includes a first variable resistor R1. One terminal of the first variable resistor R1 is connected to one end of the power terminal unit 100. Such a first variable resistor R1 controls the entire current introduced from the power terminal unit 100.

Also, the auxiliary variable current unit 120 includes first, second, and third auxiliary variable current units 121, 122, and 123 connected in parallel. The first to third auxiliary variable current units 121, 122, and 123 include second, third, and fourth variable resistors R2, R3, and R4, respectively, each of which has one terminal connected in parallel with the other terminal of the first variable resistor R1.

The light emitting unit 130 includes red, green, and blue light emitting units 131, 133, and 135 including red, green, and blue LEDs, respectively.

Here, the red light emitting unit 131 includes a first red light emitting unit 131a disposed between the other terminal of the second variable resistor R2 and the other end of the power terminal unit 100 and including at least one of first red LEDs, and a second red light emitting unit 131b connected in parallel with the first red light emitting unit 131a and including at least one of second red LEDs. The first and second red LEDs of the first and second red light emitting units 131a and 131b are connected to each other such that their polarities are reversed between the other terminal of the second variable resistor R2 and the other end of the power terminal unit 100.

In other words, when an anode terminal and a cathode terminal of the first red LED are connected to the other terminal of the second variable resistor R2 and the other end of the power terminal unit 100, respectively, a cathode terminal and an anode terminal of the second red LED are connected to the other terminal of the second variable resistor R2 and the other end of the power terminal unit 100, respectively.

The red light emitting unit 131 may further include a third or fourth red light emitting unit in addition to the first and second red light emitting units 131a and 131b.

The green light emitting unit 133 is divided into first and second green light emitting units 133a and 133b. Here, the first green light emitting unit 133a includes at least one of first green LEDs and the second green light emitting unit 133b includes at least one of second green LEDs.

The first and second green LEDs of the first and second green light emitting units 133a and 133b are connected to each other such that their polarities are reversed between the other terminal of the third variable resistor R3 and the other end of the power terminal unit 100.

The detailed descriptions other than the above-described configuration of the green light emitting unit 133 will be covered by the aforementioned descriptions related to the configuration of the red light emitting unit 131 since they are very similar to each other.

Also, the blue light emitting unit 135 is divided into first and second blue light emitting units 135a and 135b. Here, the first blue light emitting unit 135a includes at least one of first blue LEDs and the second blue light emitting unit 135b includes at least one of second blue LEDs.

The first and second blue LEDs of the first and second blue light emitting units 135a and 135b are connected to each other such that their polarities are reversed between the other terminal of the fourth variable resistor R4 and the other end of the power terminal unit 100.

The detailed descriptions other than the above-described configuration of the blue light emitting unit 135 will be also covered by the aforementioned descriptions related to the configuration of the red light emitting unit 131 since they are very similar to each other.

However, the invention will not be construed as limited to the configuration of the light emitting unit 130 as illustrated in FIG. 1.

In other words, it is preferable to include an equal number of LEDs in the first and second red light emitting units 131a and 131b of the red light emitting unit 131, the first and second green light emitting units 133a and 133b of the green light emitting unit 133, or the first and second blue light emitting units 135a and 135b of the blue light emitting unit 135 that have the same color and are connected by a reversed-polarity connection. However, the number of LEDs may vary between the different colored sub-light emitting units, for example, between the first red light emitting unit 131a and the first green light emitting unit 133a.

This is intended for driving different colored LEDs in a particular voltage section at the same time, or reducing the relatively intensive brightness level of a particular color in the LED illumination apparatus. When the light emitting unit 130 is initially designed, design methods may vary according to a system's requirements.

Therefore, the configuration of LEDs in the light emitting unit 130 may be diversely modified and varied to achieve the objects of the invention without departing from the spirit and scope of the invention.

The method of driving the LED illumination apparatus will now be described with reference to FIG. 1.

When the AC power source is applied to the power terminal unit 100, the first red, green, and blue light emitting units 131a, 133a, and 135a of the light emitting unit 130 emit light by positive polarity voltage, and the second red, green, and blue light emitting units 131b, 133b, and 135b of the light emitting unit 130 emit light by negative polarity voltage.

Therefore, the red, green and blue light emitting units 131, 133, and 135 are continuously driven during one period of the AC power source, whereby light wavelengths emitted from the respective light emitting units are combined to form white light.

On the basis of such white light, when the first variable resistor R1 of the main variable current unit 110 is controlled, current values of the LEDs included in the red, green, and blue light emitting units 131, 133, and 135 are controlled at the same time, whereby the overall brightness level of the white light is controlled.

When it is intended to display red light and control the brightness levels thereof, resistance values are maximized in the third and fourth variable resistors R3 and R4 of the green and blue light emitting units 133 and 135, thereby reducing the current flowing through the green and blue light emitting units 133 and 135 to a current value close to zero.

Then, when the first variable resistor R1 of the main variable current unit 110 or the second variable resistor R2 of the auxiliary variable current unit 120 is controlled, the brightness levels of the red light are controlled.

Also, when it is intended to display yellow light, a resistance value is maximized in the fourth variable resistor R4 of the blue light emitting unit 135, thereby reducing the current flowing through the blue light emitting unit 135 to a current value close to zero. As a result, the red and green light wavelengths, provided by the red and green light emitting units 131 and 133, are mixed to form yellow light.

At this time, a resistance value is controlled in the first variable resistor R1 of the main variable current unit 110, thereby allowing for the control of the brightness levels of the yellow light.

By the above-described method, red, green, and blue light can be displayed. Also, mixing at least two of light wavelengths makes it possible to display light in a variety of colors.

For example, the LED illumination apparatus according to the exemplary embodiment of the invention may be used as a desk lamp. In this case, changing the atmosphere of a study session, according to subject, may lead to improved learning efficiency. Supposing that the mathematics study atmosphere is matched with red light, the English study atmosphere may be matched with yellow light.

That is, since the LED illumination apparatus according to the exemplary embodiment of the invention is able to display various colors and control the brightness levels thereof, it may be suitable for mood lights.

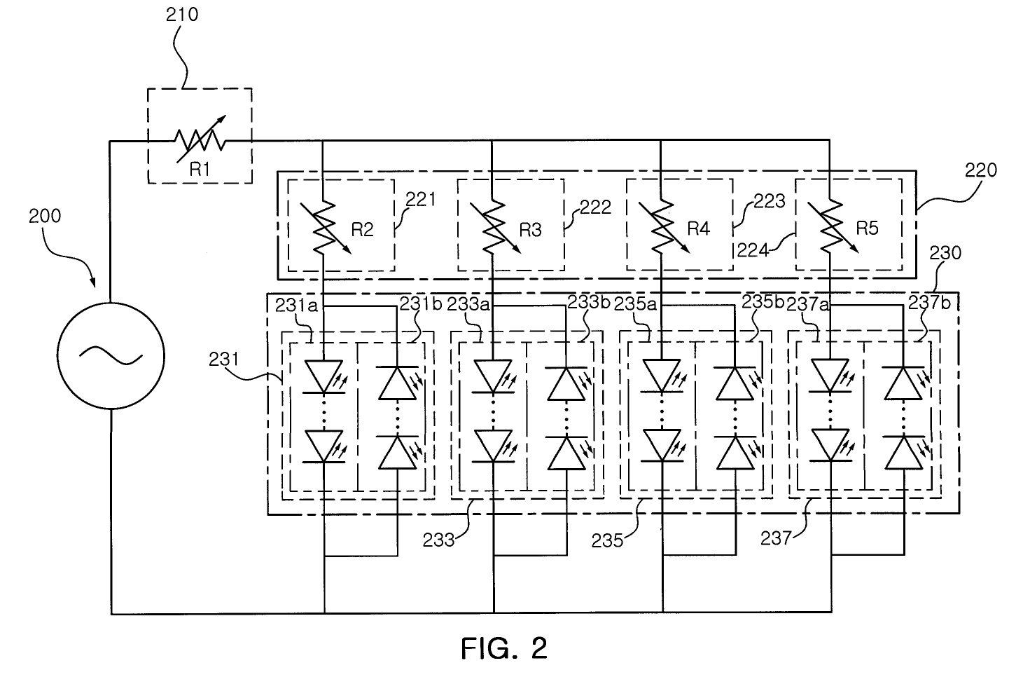

FIG. 2 illustrates a configuration for an illumination apparatus using an LED according to another exemplary embodiment of the present invention.

As shown in FIG. 2, an LED illumination apparatus according to another exemplary embodiment of the invention includes a power terminal unit 200 to which an AC power source is applied, a main variable current unit 210 connected to one end of the power terminal unit 200 and controlling the entire current, an auxiliary variable current unit 220 connected in parallel with an output port of the main variable current unit 210, dividing the current provided from the main variable current unit 210 into a plurality of current levels corresponding to a plurality of paths and controlling the plurality of divided current levels, and a light emitting unit 230 disposed between the auxiliary variable current unit 220 and the other end of the power terminal unit 200. Here, the light emitting unit 230 includes red, green, blue, and white LEDs, so as to display various colors and have high color rendering abilities.

Through one end and the other end of the power terminal unit 200, a 110V or 220V common power source is applied.

The main variable current unit 210 includes a first variable resistor R1. One terminal of the first variable resistor R1 is connected to one end of the power terminal unit 200. Such a first variable resistor R1 controls the entire current introduced from the power terminal unit 200.

Also, the auxiliary variable current unit 220 includes first, second, third, and fourth auxiliary variable current units 221, 222, 223, and 224 connected in parallel. The first to fourth auxiliary variable current units 221, 222, 223, and 224 include second, third, fourth, and fifth variable resistors R2, R3, R4, and R5, respectively, each of which has one terminal connected in parallel with the other terminal of the first variable resistor R1.

The light emitting unit 230 includes red, green, blue, and white light emitting units 231, 233, 235, and 237 including red, green, blue, and white LEDs, respectively.

Here, the red light emitting unit 231 includes a first red light emitting unit 231a disposed between the other terminal of the second variable resistor R2 and the other end of the power terminal unit 200 and including at least one of first red LEDs, and a second red light emitting unit 231b connected in parallel with the first red light emitting unit 231a and including at least one of second red LEDs. When a plurality of first red LEDs are included in the first red light emitting unit 231a, they are connected to each other in series. When a plurality of second red LEDs are included in the second red light emitting unit 231b, they are connected to each other in series. Here, the first and second red LEDs of the first and second red light emitting units 231a and 231b are connected to each other such that their polarities are reversed between the other terminal of the second variable resistor R2 and the other end of the power terminal unit 200.

In other words, when an anode terminal and a cathode terminal in the first red LED are connected to the other terminal of the second variable resistor R2 and the other end of the power terminal unit 200, respectively, a cathode terminal and an anode terminal in the second red LED are connected to the other terminal of the second variable resistor R2 and the other end of the power terminal unit 200, respectively.

The red light emitting unit 231 may further include a third or fourth red light emitting unit in addition to the first and second red light emitting units 231a and 231b.

The green light emitting unit 233 is divided into first and second green light emitting units 233a and 233b. Here, the first green light emitting unit 233a includes at least one of first green LEDs and the second green light emitting unit 233b includes at least one of second green LEDs.

The first and second green LEDs of the first and second green light emitting units 233a and 233b are connected to each other such that their polarities are reversed between the other terminal of the third variable resistor R3 and the other end of the power terminal unit 200.

The blue light emitting unit 235 is divided into first and second blue light emitting units 235a and 235b. Here, the first blue light emitting unit 235a includes at least one of first blue LEDs and the second blue light emitting unit 235b includes at least one of second blue LEDs.

The first and second blue LEDs of the first and second blue light emitting units 235a and 235b are connected to each other such that their polarities are reversed between the other terminal of the fourth variable resistor R4 and the other end of the power terminal unit 200.

The white light emitting unit 237 is divided into first and second white light emitting units 237a and 237b. Here, the first white light emitting unit 237a includes at least one of first white LEDs and the second white light emitting unit 237b includes at least one of second white LEDs.

The first and second white LEDs of the first and second white light emitting units 237a and 237b are connected to each other such that their polarities are reversed between the other terminal of the fifth variable resistor R5 and the other end of the power terminal unit 200.

The detailed descriptions other than the above-described configurations of the green, blue, and white light emitting units 233, 235 and 237 will be covered by the aforementioned descriptions related to the configuration of the red light emitting unit 231 since they are very similar to each other.

In the embodiment illustrated in FIG. 2 just as in the embodiment illustrated in FIG. 1, it is preferable to include an equal number of LEDs in the first and second red light emitting units 231a and 231b of the red light emitting unit 231, the first and second green light emitting units 233a and 233b of the green light emitting unit 233, the first and second blue light emitting units 235a and 235b of the blue light emitting unit 235, or the first and second white light emitting units 237a and 237b of the white light emitting unit 237 that have the same color and are connected by a reversed-polarity connection. However, the number of LEDs may vary between the different colored sub-light emitting units, for example, between the first red light emitting unit 231a and the first green light emitting unit 233a.

Therefore, the configuration of LEDs in the light emitting unit 230 may be diversely modified and varied, so the invention will not be construed as limited to that configuration.

In order words, when the light emitting unit 230 is initially designed, design methods may vary according to a system's requirements so as to drive different colored LEDs in a particular voltage section at the same time, or reduce the relatively intensive brightness level of a particular color in the LED illumination apparatus.

As a result, the LED illumination apparatus according to this embodiment of the invention further includes the white light emitting unit 237, thereby realizing a high color rendering ability relative to the embodiment illustrated in FIG. 1. That is, when observing an object in the atmosphere produced by the LED illumination apparatus according to the embodiment illustrated in FIG. 2, relative to the embodiment illustrated in FIG. 1, the color of the displayed object is similar to when the object is lit by natural light.

For example, when a red-colored object is irradiated by light produced from the LED illumination apparatus in a manner that drives the red and white light emitting units 231 and 237 at the same time, the color of the object is quite similar to when the object is irradiated by natural light.

At this time, a resistance value is controlled in the first variable resistor R1 of the main variable current unit 210 and/or the fifth variable resistor R5 controlling the brightness level of the white light emitting unit 237, thereby finely controlling color rendering.

Furthermore, the invention may be realized by only the auxiliary variable current unit 120 and 220 without the main variable current unit 110 and 210 in the embodiments illustrated in FIGS. 1 and 2.

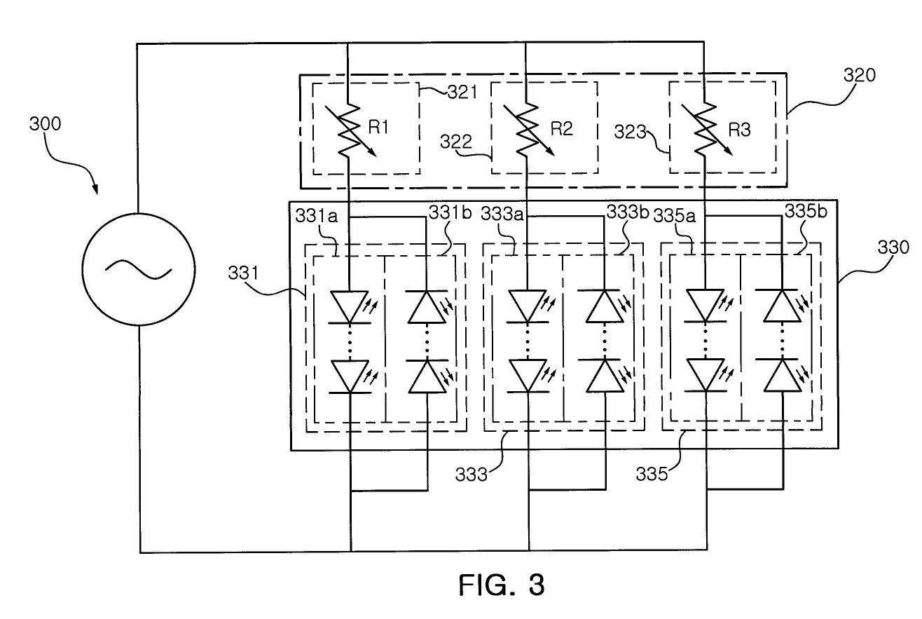

FIG. 3 illustrates a configuration for an illumination apparatus using an LED according to another exemplary embodiment of the present invention.

As shown in FIG. 3, an LED illumination apparatus according to an exemplary embodiment of the invention includes a power terminal unit 300 having one end and the other end to which an AC power source is applied, a variable current unit 320 connected to one end of the power terminal unit 300, dividing the current provided from the power terminal unit 300 into a plurality of current levels corresponding to a plurality of paths, and controlling the plurality of divided current levels, respectively, and a light emitting unit 330 disposed between the variable current unit 320 and the other end of the power terminal unit 300. Here, the light emitting unit 330 includes red, green, and blue LEDs.

Through one end and the other end of the power terminal unit 300, a 110V or 220V common power source is applied.

The variable current unit 320 includes first, second, and third variable current units 321, 322, and 323 connected in parallel. The first to third variable current units 321, 322, and 323 include variable resistors R1, R2, and R3, respectively, each of which is connected in parallel with one end of the power terminal unit 300.

Also, it is preferable to include an equal number of LEDs in first and second red light emitting units 331a and 331b of the red light emitting unit 331, first and second green light emitting units 333a and 333b of the green light emitting unit 333, or first and second blue light emitting units 335a and 335b of the blue light emitting unit 335 that have the same color and are connected by a reversed-polarity connection. However, the number of LEDs may vary between the different colored sub-light emitting units, for example, between the first red light emitting unit 331a and the first green light emitting unit 333a.

Except for such a configuration, this embodiment is very similar to the embodiments illustrated in FIGS. 1 and 2. In this regard, the detailed descriptions related to this embodiment will be covered by the aforementioned descriptions related to the embodiments illustrated in FIGS. 1 and 2.

In the configuration illustrated in FIG. 3, the first to third variable resistors R1, R2, and R3 are controlled at the same time, thereby controlling the brightness levels of white light. Also, the first to third variable resistors R1, R2, and R3 are controlled to have different resistance values, thereby displaying various colors.

For example, when it is intended to display yellow light, a resistance value of the third variable resistor R3 is maximized to reduce a current value to zero. The brightness level control of the yellow light is realized by controlling the first and second variable resistors R1 and R2 at the same time.

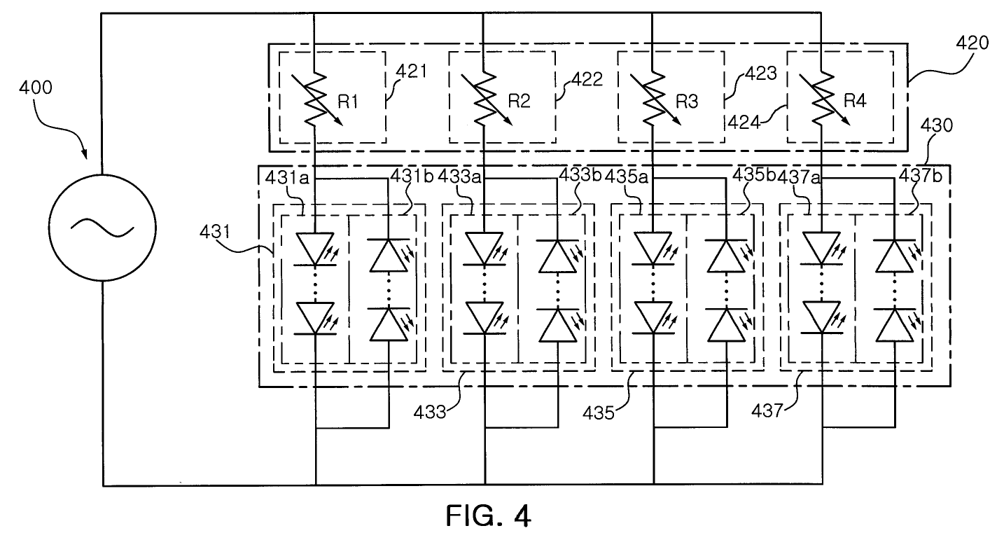

As illustrated in FIG. 4, an LED illumination apparatus may be realized by applying the technical ideas of the embodiment illustrated in FIG. 3 to the embodiment illustrated in FIG. 2.

Referring to FIG. 4, an LED illumination apparatus according to another exemplary embodiment of the present invention includes a power terminal unit 400 having one end and the other end to which an AC power source is applied, a variable current unit 420 connected to one end of the power terminal unit 400, dividing the current provided from the power terminal unit 400 into a plurality of current levels corresponding to a plurality of paths and controlling the plurality of divided current levels, respectively, and a light emitting unit 430 disposed between the variable current unit 420 and the other end of the power terminal unit 400. Here, just as the configuration of the light emitting unit 230 as illustrated in FIG. 2, the light emitting unit 430 includes red, green, blue, and white light emitting units 431, 433, 435, and 437, each of which includes first and second red LEDs 431a and 431b, first and second green LEDs 433a and 433b, first and second blue LEDs 435a and 435b, and first and second white LEDs 437a and 437b, respectively.

Also, the variable current unit 420 includes first, second, third, and fourth variable current units 421, 422, 423, and 424 connected in parallel. The first to fourth variable current units 421, 422, 423, and 424 include first, second, third, and fourth variable resistors R1, R2, R3, and R4, respectively, each of which is connected in parallel with one end of the power terminal unit 400.

Except for such a configuration, this embodiment is very similar to the embodiments illustrated in FIGS. 2 and 3. In this regard, the detailed descriptions related to this embodiment will be covered by the aforementioned descriptions related to the embodiments illustrated in FIGS. 2 and 3.

As set forth above, according to exemplary embodiments of the invention, the LED illumination apparatus is able to display various colors and control a color's brightness level, so it is advantageous to mood lights. Also, due to high color rendering abilities, when an object is irradiated by the LED illumination apparatus, its own color can be displayed, similar to when the object is irradiated by natural light.

While the present invention has been shown and described in connection with the exemplary embodiments, it will be apparent to those skilled in the art that modifications and variations can be made without departing from the spirit and scope of the invention as defined by the appended claims.

What is claimed is:

1. An illumination apparatus using a light emitting diode (LED), comprising:
a power terminal unit having one end and the other end to which an alternating current power source is applied;
a variable current unit connected to one end of the power terminal unit, dividing current provided from the power terminal unit into a plurality of current levels corresponding to a plurality of paths, and comprising first, second and third variable current units controlling the plurality of divided current levels, respectively; and
a light emitting unit comprising a red light emitting unit disposed between the first variable current unit and the other end of the power terminal unit, a green light emitting unit disposed between the second variable current unit and the other end of the power terminal unit, and a blue light emitting unit disposed between the third variable current unit and the other end of the power terminal unit.

2. The illumination apparatus of claim 1, wherein each of the first, second and third variable current units comprises a variable resistor.

3. The illumination apparatus of claim 2, wherein each of the red, green, and blue light emitting units comprises first and second red light emitting units connected in parallel, first and second green light emitting units connected in parallel, and first and second blue light emitting units connected in parallel, respectively.

4. The illumination apparatus of claim 3, wherein each of the first and second red light emitting units, each of the first and second green light emitting units, and each of the first and second blue light emitting units comprise one or at least two of series-connected red, green, and blue LEDs, respectively, and
each of the first and second red light emitting units, each of the first and second green light emitting units, and each of the first and second blue light emitting units have their respective polarities connected by a reversed-polarity connection.

5. The illumination apparatus of claim 2, wherein the variable current unit further comprises a fourth variable current unit connected in parallel with the third variable current unit.

6. The illumination apparatus of claim 5, wherein the light emitting unit further comprises first and second white light emitting units disposed between the fourth variable current unit and the other end of the power terminal unit and connected in parallel to each other.

7. The illumination apparatus of claim 6, wherein each of the first and second white light emitting units comprises one or at least two of series-connected white LEDs, and
the first and second white light emitting units are connected by a reversed-polarity connection.

8. An illumination apparatus using a light emitting diode (LED), comprising:
a power terminal unit having one end and the other end to which an alternating current power source is applied;
a main variable current unit connected to one end of the power terminal unit and controlling current;
an auxiliary variable current unit connected to an output port of the main variable current unit, dividing current provided from the main variable current unit into a plurality of current levels corresponding to a plurality of paths, and comprising first, second and third auxiliary variable current units controlling the plurality of divided current levels, respectively; and
a light emitting unit comprising a red light emitting unit disposed between the first auxiliary variable current unit and the other end of the power terminal unit, a green light emitting unit disposed between the second auxiliary variable current unit and the other end of the power terminal unit, and a blue light emitting unit disposed between the third auxiliary variable current unit and the other end of the power terminal unit.

9. The illumination apparatus of claim 8, the main variable current unit and each of the first, second and third auxiliary variable current units comprise a variable resistor.

10. The illumination apparatus of claim 8, wherein each of the red, green, and blue light emitting units comprises first and second red light emitting units connected in parallel, first and second green light emitting units connected in parallel, and first and second blue light emitting units connected in parallel, respectively.

11. The illumination apparatus of claim 10, wherein each of the first and second red light emitting units, each of the first and second green light emitting units, and each of the first and second blue light emitting units comprise one or at least two of series-connected red, green, and blue LEDs, respectively, and
each of the first and second red light emitting units, each of the first and second green light emitting units, and each of the first and second blue light emitting units have their respective polarities connected by a reversed-polarity connection.

12. The illumination apparatus of claim 9, wherein the auxiliary variable current unit further comprises a fourth auxiliary variable current unit connected in parallel with the third auxiliary variable current unit.

13. The illumination apparatus of claim 12, wherein the light emitting unit further comprises first and second white light emitting units disposed between the fourth auxiliary variable current unit and the other end of the power terminal unit and connected in parallel to each other.

14. The illumination apparatus of claim 13, wherein each of the first and second white light emitting units comprises one or at least two of series-connected white LEDs, and
the first and second white light emitting units are connected by a reversed-polarity connection.
